(19) United States
(12) Patent Application Publication
(10) Pub. No.: US 2024/0020685 A1
(43) Pub. Date: Jan. 18, 2024

(54) METHOD, APPARATUS, AND COMPUTER READABLE MEDIUM FOR PROVIDING MANAGEMENT OF STORED BALANCE CARDS

(71) Applicant: GROUPON, INC., Chicago, IL (US)

(72) Inventor: Tali Rapaport, Palo Alto, CA (US)

(21) Appl. No.: 18/333,048

(22) Filed: Jun. 12, 2023

Related U.S. Application Data
(63) Continuation of application No. 14/705,449, filed on May 6, 2015, now abandoned.
(60) Provisional application No. 61/989,918, filed on May 7, 2014.

(51) Int. Cl. G06Q 20/36

(52) U.S. Cl. CPC G06Q 20/3674

(57) ABSTRACT

Provided herein are systems, methods and computer readable media for programmatically providing stored balance card information and performing transactions using a stored balance card. An example method includes associating a first stored balance card with a user, and receiving electronic transaction information. The electronic transaction information includes a transaction amount for a first transaction completed using the first stored balance card at a first merchant associated with the first stored balance card. The method also includes deriving, using a processor, stored balance card information from the electronic transaction information. The stored balance card information includes information associated with the first one stored balance card. The method also includes providing the stored balance card information to the user. Methods, systems, and apparatuses for performing transactions using a stored balance card and using a wallet account to cover overages in transactions performed using stored balance card are also provided.

### CROSS REFERENCE TO RELATED APPLICATIONS

This application is a continuation of and claims priority to U.S. application Ser. No. 14/705,449, filed May 6, 2015, which claims priority to U.S. Provisional Application No. 61/989,918, filed May 7, 2014, each of which are incorporated by reference herein in their entirety.

### FIELD

Embodiments of the invention relate, generally, to providing an interface to a commerce system and, more particularly, to a method, apparatus, and computer readable medium for providing a framework to access, display, analyze and/or report stored balance card information.

### BACKGROUND

Applicant has discovered problems with current methods for managing stored balance cards. Through applied effort, ingenuity, and innovation, Applicant has solved many of these identified problems by developing a solution that is embodied by the present invention, which is described in detail below.

### BRIEF SUMMARY

In general, embodiments of the present invention provide herein systems, methods and computer readable media for providing stored balance cards and providing services related to stored balance cards to consumers and merchants. These services may include tracking stored balance card balances, monitoring transactions performed by stored balance cards, performing analytics on stored balance card information, and reporting stored balance card information to consumers and merchants. In providing such functionality, embodiments may advantageously provide a system and framework for managing stored balance cards that can provide information related to multiple different merchants and which also is capable of functioning separately from payment processing and/or banking systems. Embodiments may further leverage capabilities of a promotion and marketing service to provide for the sale and marketing of stored balance cards and other merchant offers based on stored balance card information.

Embodiments may include a method for providing stored balance card information. The method includes associating a first stored balance card with a user, and receiving electronic transaction information. The electronic transaction information includes a transaction amount for a first transaction completed using the first stored balance card at a first merchant associated with the first stored balance card. The method also includes deriving, using a processor, stored balance card information from the electronic transaction information. The stored balance card information includes information associated with the first one stored balance card. The method also includes providing the stored balance card information to the user. The user may be the merchant. The user may be a consumer. Embodiments of the method may also include associating a second stored balance card with the user. The second stored balance card may be associated with a second merchant other than the first merchant. The method may also include receiving additional electronic transaction information. The additional electronic transaction information may include a transaction amount for a second transaction completed using the second stored balance card at the second merchant. Deriving the stored balance card information may further include deriving the stored balance card information from the additional electronic transaction information. The electronic transaction information may further include an email address, a phone number, an expiration date of the first stored balance card, an identifier for one or more products or services purchased in the transaction, or a merchant location.

The stored balance card information may be determined by a promotion and marketing service and wherein the electronic transaction information comprises an indicator that indicates that the transaction was approved by a payment processor, and wherein the payment processor is not the promotion and marketing service. The stored balance card information may be a balance associated with the first stored balance card and wherein the stored balance card information is provided to a consumer via a website. The stored balance card information may include a balance of a plurality of stored balance cards each associated with different merchants. The electronic transaction information may be provided using an application programming interface. The application programming interface may be coupled to a merchant point-of-sale.

Embodiments may also provide an apparatus for providing stored balance card information. The apparatus includes at least one processor coupled to a memory, the memory comprising computer executable instructions that, when executed by the processor, configure the apparatus. The instructions configure the apparatus to associate a first stored balance card with a user, and receive electronic transaction information. The electronic transaction information includes a transaction amount for a first transaction completed using the first stored balance card at a first merchant associated with the first stored balance card. The apparatus is further configured to derive stored balance card information from the electronic transaction information. The stored balance card information includes information associated with the first one stored balance card. The apparatus is further configured to provide the stored balance card information to the user. In some embodiments, the user is the merchant. In some embodiments, the user is a consumer. The apparatus may be further configured to associate a second stored balance card with the user. The second stored balance card may be associated with a second merchant other than the first merchant. The apparatus may also be configured to receive additional electronic transaction information. The additional electronic transaction information may include a transaction amount for a second transaction completed using the second stored balance card at the second merchant, and deriving the stored balance card information may further include deriving the stored balance card information from the additional electronic transaction information.

The electronic transaction information may further include an email address, a phone number, an expiration date of the first stored balance card, an identifier for one or more products or services purchased in the transaction, or a merchant location. The stored balance card information may be determined by a promotion and marketing service and the electronic transaction information may include an indicator that indicates that the transaction was approved by a payment processor. The payment processor may not be the promotion and marketing service. The stored balance card information may be a balance associated with the first stored balance card and the stored balance card information may be provided to a consumer via a website. The stored balance card information may further include a balance of a plurality of stored balance cards each associated with different merchants. The electronic transaction information may be provided using an application programming interface. The application programming interface may be coupled to a merchant point-of-sale.

Embodiments may also include a non-transitory computer readable storage medium comprising instructions that, when executed by a processor, configure the processor. The instructions configure the processor to associate a first stored balance card with a user, and to receive electronic transaction information. The electronic transaction information includes a transaction amount for a first transaction completed using the first stored balance card at a first merchant associated with the first stored balance card. The instructions further configure the processor to derive stored balance card information from the electronic transaction information. The stored balance card information includes information associated with the first one stored balance card. The instructions also configure the processor to provide the stored balance card information to the user.

In some embodiments, the user is the merchant. In some embodiments, the user is a consumer. The instructions may also configure the processor to associate a second stored balance card with the user. The second stored balance card may be associated with a second merchant other than the first merchant. The instructions may also configure the processor to receive additional electronic transaction information. The additional electronic transaction information may include a transaction amount for a second transaction completed using the second stored balance card at the second merchant. Deriving the stored balance card information may include deriving the stored balance card information from the additional electronic transaction information. The electronic transaction information may further include an email address, a phone number, an expiration date of the first stored balance card, an identifier for one or more products or services purchased in the transaction, or a merchant location. The stored balance card information may be determined by a promotion and marketing service. The electronic transaction information may include an indicator that indicates that the transaction was approved by a payment processor. The payment processor may not be the promotion and marketing service. The stored balance card information may be a balance associated with the first stored balance card and the stored balance card information may be provided to a consumer via a website. The stored balance card information may include a balance of a plurality of stored balance cards each associated with different merchants. The electronic transaction information may be provided using an application programming interface. The application programming interface may be coupled to a merchant point-of-sale.

Embodiments may also provide a method for performing a transaction using a stored balance card. The method includes receiving a value of a transaction and an identifier for a stored balance card used to perform the transaction. The stored balance card is associated with at least one particular merchant. The method also includes determining a balance remaining for the stored balance card, determining that the balance is less than the value of the transaction, determining a remainder value representing the difference between the balance and the value of the transaction, and charging, using the processor, the remainder value to a wallet account linked to the stored balance card, wherein the wallet account is different than the balance remaining for the stored balance card.

The method may further include verifying that sufficient funds remain in the wallet account to cover the remainder value before charging the remainder value to the wallet account. The wallet account may be maintained by a party other than the at least one particular merchant. The method may also include providing funds from the wallet account to the at least one particular merchant in response to charging the remainder value to the wallet account. The stored balance card may be associated with a combined stored balance account, and the wallet account may be associated with the combined stored balance account. The combined stored balance account may be associated with at least a plurality of stored balance cards including the stored balance card, and the wallet account may be usable to be charged for a remainder value of any transactions performed using any of the plurality of stored balance cards associated with the combined stored balance account.

Embodiments may also provide an apparatus for performing a transaction using a stored balance card, the apparatus comprising at least one processor coupled to a memory, the memory comprising computer executable instructions that, when executed by the processor, configure the apparatus to receive a value of a transaction and an identifier for a stored balance card used to perform the transaction. The stored balance card is associated with at least one particular merchant. The apparatus is further configured to determine a balance remaining for the stored balance card, to determine that the balance remaining is less than the value of the transaction, to determine a remainder value representing the difference between the balance and the value of the transaction, and to charge, using the processor, the remainder value to a wallet account linked to the stored balance card. The wallet account is different than the balance remaining for the stored balance card.

The apparatus may be further configured to verify that sufficient funds remain in the wallet account to cover the remainder value before charging the remainder value to the wallet account. The wallet account may be maintained by a party other than the at least one particular merchant. The apparatus may be further configured to provide funds from the wallet account to the at least one particular merchant in response to charging the remainder value to the wallet account. The stored balance card may be associated with a combined stored balance account, and the wallet account may be associated with the combined stored balance account. The combined stored balance account may be associated with at least a plurality of stored balance cards including the stored balance card, and the wallet account may be usable to be charged for a remainder value of any transactions performed using the plurality of stored balance cards associated with the combined stored balance account.

Embodiments may also include a non-transitory computer readable storage medium comprising instructions that, when executed by a processor, configure the processor to perform a transaction using a stored balance card. The instructions configure the processor to receive a value of a transaction and an identifier for a stored balance card used to perform the transaction. The stored balance card is associated with at least one particular merchant. The instructions further configure the processor to determine a balance remaining for the stored balance card, to determine that the balance remaining is less than the value of the transaction, to determine a remainder value representing the difference between the balance and the value of the transaction, and to charge the remainder value to a wallet account linked to the stored balance card. The wallet account is different than the balance remaining for the stored balance card.

The instructions may further configure the processor to verify that sufficient funds remain in the wallet account to cover the remainder value before charging the remainder value to the wallet account. The wallet account may be maintained by a party other than the at least one particular merchant. The instructions may further configure the processor to provide funds from the wallet account to the at least one particular merchant in response to charging the remainder value to the wallet account. The stored balance card may be associated with a combined stored balance account, and the wallet account may be associated with the combined stored balance account. The combined stored balance account may be associated with a plurality of stored balance cards including the stored balance card, and the wallet account may be usable to be charged for a remainder value of any transactions performed using the plurality of stored balance cards associated with the combined stored balance account.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 depicts an example system in accordance with some embodiments described herein;

FIG. 2 depicts a schematic block diagram of circuitry that can be included in a computing device, such as a merchant machine, consumer machine and/or promotion and marketing service, in accordance with some embodiments described herein;

FIG. 3 depicts an illustration of a dataflow for communications between a merchant device, a server, and a consumer device in accordance with some embodiments described herein;

FIG. 4 depicts an illustration of a dataflow for providing stored balance card information in accordance with some embodiments described herein;

FIG. 5 depicts a signal diagram depicting communications between a consumer device, a promotion and marketing service, and a merchant device in accordance with some embodiments described herein; and

FIGS. 6-8 depict flow charts showing exemplary processes for providing stored balance card information in accordance with some embodiments described herein.

### DETAILED DESCRIPTION

### Introduction and Definitions

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, hosts, and/or the like.

As used herein, the term “promotion and marketing service” may include a service that is accessible via one or more computing devices and that is operable to provide promotion and/or marketing services on behalf of one or more providers that are offering one or more instruments that are redeemable for goods, services, experiences and/or the like. In some examples, the promotion and marketing service may take the form of a redemption authority, a payment processor, a rewards provider, an entity in a financial network, a promoter, an agent and/or the like. As such, the service is, in some example embodiments, configured to present one or more promotions via one or more impressions, accept payments for promotions from consumers, issue instruments upon acceptance of an offer, participate in redemption, generate rewards, provide a point of sale device or service, issue payments to providers and/or or otherwise participate in the exchange of goods, services or experiences for currency, value and/or the like. The service is also, in some example embodiments, configured to offer merchant services such as promotion building (e.g., assisting merchants with selecting parameters for newly created promotions), promotion counseling (e.g., offering information to merchants to assist with using promotions as marketing), promotion analytics (e.g., offering information to merchants to provide data and analysis regarding the costs and return-on-investment associated with offering promotions), and the like.

As used herein, the terms “provider” and “merchant” may be used interchangeably and may include, but are not limited to, a business owner, consigner, shopkeeper, tradesperson, vendor, operator, entrepreneur, agent, dealer, organization or the like that is in the business of a providing a good, service or experience to a consumer, facilitating the provision of a good, service or experience to a consumer and/or otherwise operating in the stream of commerce. The “provider” or “merchant” need not actually market a product or service via the promotion and marketing service, as some merchants or providers may utilize the promotion and marketing service only for the purpose of gathering marketing information, demographic information, or the like.

As used herein, the term “consumer” should be understood to refer to a recipient of goods, services, promotions, media, or the like provided by the promotion and marketing service and/or a merchant. Consumers may include, without limitation, individuals, groups of individuals, corporations, other merchants, and the like.

As used herein, the term “promotion” may include, but is not limited to, any type of offered, presented or otherwise indicated reward, discount, coupon, credit, deal, incentive, discount, media or the like that is indicative of a promotional value or the like that upon purchase or acceptance results in the issuance of an instrument that may be used toward at least a portion of the purchase of particular goods, services and/or experiences defined by the promotion. Promotions may have different values in different contexts. For example, a promotion may have a first value associated with the cost paid by a consumer, known as an “accepted value.” When redeemed, the promotion may be used to purchase a “promotional value” representing the retail price of the goods. The promotion may also have a “residual value,” reflecting the remaining value of the promotion after expiration. Although consumers may be primarily focused on the accepted and promotional value of the promotion, a promotion may also have additional associated values. For example, a “cost value” may represent the cost to the merchant to offer the promotion via the promotion and marketing service, where the promotion and marketing service receives the cost value for each promotion sold to a consumer. The promotion may also include a “return on investment” value, representing a quantified expected return on investment to the merchant for each promotion sold.

For example, consider a promotion offered by the promotion and marketing service for a $50 meal promotion for $25 at a particular restaurant. In this example, $25 would be the accepted value charged to the consumer. The consumer would then be able to redeem the promotion at the restaurant for $50 applied toward their meal check. This $50 would be the promotional value of the promotion. If the consumer did not use the promotion before expiration, the consumer might be able to obtain a refund of $22.50, representing a 10% fee to recoup transaction costs for the merchant and/or promotion and marketing service. This $22.50 would be the residual value of the promotion. If the promotion and marketing service charged the merchant $3.00 to offer the promotion, the $3.00 fee would be the “cost value.” The “return on investment” value of the promotion might be dynamically calculated by the promotion and marketing service based on the expected repeat business generated by the marketing of the promotion, the particular location, the demographics of the consumer, and the like. For example, the return on investment value might be $10.00, reflecting the long term additional profit expected by the merchant as a result of bringing in a new customer through use of a promotion.

Promotions may be provided to consumers and redeemed via the use of an “instrument.” Instruments may represent and embody the terms of the promotion from which the instrument resulted. For example, instruments may include, but are not limited to, any type of physical token (e.g., magnetic strip cards or printed barcodes), virtual account balance (e.g., a promotion being associated with a particular user account on a merchant website), secret code (e.g., a character string that can be entered on a merchant website or point-of-sale), tender, electronic certificate, medium of exchange, voucher, or the like which may be used in a transaction for at least a portion of the purchase, acquisition, procurement, consumption or the like of goods, services and/or experiences as defined by the terms of the promotion.

In some examples, the instrument may take the form of tender that has a given value that is exchangeable for goods, services and/or experiences and/or a reduction in a purchase price of a particular good, service or experience. In some examples, the instrument may have multiple values, such as accepted value, a promotional value and/or a residual value. For example, using the aforementioned restaurant as the example provider, an electronic indication in a mobile application that shows $50 of value to be used as payment for a meal check at the restaurant. In some examples, the accepted value of the instrument is defined by the value exchanged for the instrument. In some examples, the promotional value is defined by the promotion from which the instrument resulted and is the value of the instrument beyond the accepted value. In some examples, the residual value is the value after redemption, the value after the expiry or other violation of a redemption parameter, the return or exchange value of the instrument and/or the like.

As used herein, the term “redemption” refers to the use, exchange or other presentation of an instrument for at least a portion of a good, service or experience as defined by the instrument and its related promotion. In some examples, redemption includes the verification of validity of the instrument. In other example embodiments, redemption may include an indication that a particular instrument has been redeemed and thus no longer retains an actual, promotional and/or residual value (e.g., full redemption). In other example embodiments, redemption may include the redemption of at least a portion of its actual, promotional and/or residual value (e.g., partial redemption). An example of redemption, using the aforementioned restaurant as the example provider, is the exchange of the $50 instrument and $50 to settle a $100 meal check.

As used herein, the term “impression” refers to a metric for measuring how frequently consumers are provided with marketing information related to a particular good, service, or promotion. Impressions may be measured in various different manners, including, but not limited to, measuring the frequency with which content is served to a consumer (e.g., the number of times images, websites, or the like are requested by consumers), measuring the frequency with which electronic marketing communications including particular content are sent to consumers (e.g., a number of e-mails sent to consumers or number of e-mails including particular promotion content), measuring the frequency with which electronic marketing communications are received by consumers (e.g., a number of times a particular e-mail is read), or the like. Impressions may be provided through various forms of media, including but not limited to communications, displays, or other perceived indications, such as e-mails, text messages, application alerts, mobile applications, other type of electronic interface or distribution channel and/or the like, of one or more promotions.

As used herein, the term “electronic marketing information” refers to various electronic data and signals that may be interpreted by a promotion and marketing service to provide improved electronic marketing communications. Electronic marketing information may include, without limitation, clickstream data (defined below), transaction data (defined below), location data (defined below), communication channel data (defined below), discretionary data (defined below), or any other data stored by or received by the promotion and marketing service for use in providing electronic communications to consumers.

As used herein, the term “clickstream data” refers to electronic information indicating content viewed, accessed, edited, or retrieved by consumers. This information may be electronically processed and analyzed by a promotion and marketing service to improve the quality of electronic marketing and commerce transactions offered by, through, and in conjunction with the promotion and marketing service. It should be understood that the term “clickstream” is not intended to be limited to mouse clicks. For example, the clickstream data may include various other consumer interactions, including without limitation, mouse-over events and durations, the amount of time spent by the consumer viewing particular content, the rate at which impressions of particular content result in sales associated with that content, demographic information associated with each particular consumer, data indicating other content accessed by the consumer (e.g., browser cookie data), the time or date on which content was accessed, the frequency of impressions for particular content, associations between particular consumers or consumer demographics and particular impressions, and/or the like.

As used herein, the term “transaction data” refers to electronic information indicating that a transaction is occurring or has occurred via either a merchant or the promotion and marketing service. Transaction data may also include information relating to the transaction. For example, transaction data may include consumer payment or billing information, consumer shipping information, items purchased by the consumer, a merchant rewards account number associated with the consumer, the type of shipping selected by the consumer for fulfillment of the transaction, or the like.

As used herein, the term “location data” refers to electronic information indicating a particular location. Location data may be associated with a consumer, a merchant, or any other entity capable of interaction with the promotion and marketing service. For example, in some embodiments location data is provided by a location services module of a consumer mobile device. In some embodiments, location data may be provided by a merchant indicating the location of consumers within their retail location. In some embodiments, location data may be provided by merchants to indicate the current location of the merchant (e.g., a food truck or delivery service). It should be appreciated that location data may be provided by various systems capable of determining location information, including, but not limited to, global positioning service receivers, indoor navigation systems, cellular tower triangulation techniques, video surveillance systems, or radio frequency identification (RFID) location systems.

As used herein, the term “communication channel data” refers to electronic information relating to the particular device or communication channel upon which a merchant or consumer communicates with the promotion and marketing service. In this regard, communication channel data may include the type of device used by the consumer or merchant (e.g., smart phone, desktop computer, laptop, netbook, tablet computer), the Internet Protocol (IP) address of the device, the available bandwidth of a connection, login credentials used to access the channel (e.g., a user account and/or password for accessing the promotion and marketing service), or any other data pertaining to the communication channel between the promotion and marketing service and an entity external to the promotion and marketing service.

As used herein, the term “discretionary data” refers to electronic information provided by a merchant or consumer explicitly to the promotion and marketing service in support of improved interaction with the promotion and marketing service. Upon registering with the promotion and marketing service or at any time thereafter, the consumer or merchant may be invited to provide information that aids the promotion and marketing service in providing services that are targeted to the particular needs of the consumer or merchant. For example, a consumer may indicate interests, hobbies, their age, gender, or location when creating a new account. A merchant may indicate the type of goods or services provided, their retail storefront location, contact information, hours of operation, or the like.

It should be appreciated that the term “discretionary data” is intended to refer to information voluntarily and explicitly provided to the promotion and marketing service, such as by completing a form or survey on a website or application hosted by the promotion and marketing service. However, is should be appreciated that the examples of discretionary data provided above may also be determined implicitly or through review or analysis of other electronic marketing information provided to the promotion and marketing service. It should also be appreciated that the promotion and marketing service may also gate access to certain features or tools based on whether certain discretionary data has been provided. For example, the consumer may be required to provide information relating to their interests or location during a registration process.

As used herein, the term “offering parameters” refers to terms and conditions under which the promotion is offered by a promotion and marketing service to consumers. These offering parameters may include parameters, bounds, considerations and/or the like that outline or otherwise define the terms, timing, constraints, limitations, rules or the like under which the promotion is sold, offered, marketed, or otherwise provided to consumers. Example offering parameters include, using the aforementioned restaurant as the example provider, limit one instrument per person, total of 100 instruments to be issued, a run duration of when the promotion will be marketed via the promotion and marketing service, and parameters for identifying consumers to be offered the promotion (e.g., factors influencing how consumer locations are used to offer a promotion).

As used herein, the term “redemption parameters” refers to terms and conditions for redeeming or otherwise obtaining the benefit of promotions obtained from a promotion and marketing service. The redemption parameters may include parameters, bounds, considerations and/or the like that outline the term, timing, constraints, limitations, rules or the like for how and/or when an instrument may be redeemed. For example, the redemption parameters may include an indication that the instrument must be redeemed prior to a specified deadline, for a specific good, service or experience and/or the like. For example, using the aforementioned restaurant as the example provider, the redemption parameters may specify a limit of one instrument per visit, that the promotion must be used in store only, or that the promotion must be used by a certain date.

As used herein, the term “promotion content” refers to display factors or features that influence how the promotion is displayed to consumers. For example, promotion content may include an image associated with the promotion, a narrative description of the promotion or the merchant, a display template for association with the promotion, or the like. For example, merchant self-service indicators (defined below) may be used to identify promotion offers that were generated by merchants with similar characteristics to the merchant self-service indicators. Various other factors may be used to generate the promotion offer, such as the success of the promotion offers generated by the merchants with similar characteristics, the product availability of the merchant, and the like.

As used herein, the term “promotion component” is used to refer to elements of a particular promotion that may be selected during a promotion generation process. Promotion components may include any aspect of a promotion, including but not necessarily limited to offering parameters, redemption parameters, and promotion content. For example, promotion components may include, but are not limited to, promotion titles, promotion ledes (e.g., a short text phrase displayed under a promotion title), promotion images, promotion prices, promotion discount levels, promotion style sheets, promotion fonts, promotion e-mail subjects, promotion quantities, promotion fine print options, promotion fees assessed to the merchant by the promotion and marketing service, or the like. Promotion components may also include various flags and settings associated with registration and verification functions for a merchant offering the promotion, such as whether the identity of the merchant has been verified, whether the merchant is registered with the promotion and marketing service, or the like.

As used herein, the terms “electronic marketing communication” and “message” refer to any electronically generated information content provided by the promotion and marketing service to a consumer for the purpose of marketing a promotion, good, or service to the consumer. Electronic marketing communications may include any email, short message service (SMS) message, web page, application interface, or the like electronically generated for the purpose of attempting to sell or raise awareness of a product, service, promotion, or merchant to the consumer.

It should be appreciated that the term “electronic marketing communication” implies and requires some portion of the content of the communication to be generated via an electronic process. For example, a telephone call made from an employee of the promotion and marketing service to a consumer for the purpose of selling a product or service would not qualify as an electronic marketing communication, even if the identity of the call recipient was selected by an electronic process and the call was dialed electronically, as the content of the telephone call is not generated in an electronic manner. However, a so-called “robo-call” with content programmatically selected, generated, or recorded via an electronic process and initiated by an electronic system to notify a consumer of a particular product, service, or promotion would qualify as an electronic marketing communication. Similarly, a manually drafted e-mail sent from an employee of the promotion and marketing service to a consumer for the purpose of marketing a product would not qualify as an electronic marketing communication. However, a programmatically generated email including marketing materials programmatically selected based on electronic marketing information associated with the recipient would qualify as an electronic marketing communication.

As used herein, the term “business analytic data” refers to data generated by the promotion and marketing service based on electronic marketing information to assist with the operation of the promotion and marketing service and/or one or more merchants. The various streams of electronic marketing information provided to and by the promotion and marketing service allow for the use of sophisticated data analysis techniques that may be employed to identify correlations, relationships, and other associations among elements of electronic marketing information. These associations may be processed and formatted by the promotion and marketing service to provide reports, recommendations, and services both internal to the promotion and marketing service and to merchants in order to improve the process by which merchants and promotion and marketing service engage with consumers. For example, the promotion and marketing service may analyze the electronic marketing information to identify an increased demand for a particular product or service, and provide an electronic report to a merchant suggesting the merchant offer the particular product or service. Alternatively, the promotion and marketing service may identify that a particular product or service is not selling or resulting in the merchant losing money, customers, or market share (e.g., after consumers order a particular menu item, they never come back to the merchant), and suggest that the merchant should discontinue offering that product or service.

It should be appreciated that the term “business analytic data” is intended to refer to electronically and programmatically generated data. For example, a printed report or letter manually drafted by an employee of the promotion and marketing service would not be said to include business analytic data, even if said data was used by the employee during the drafting process, while a data disk or downloaded file containing analytics generated by the promotion and marketing service would be considered business analytic data.

As used herein, the term “stored balance card” is used to refer to any instrument that may be redeemable for a particular value of purchases at a particular merchant. For example, gift cards are an example of a stored balance card. The term should be understood not to require a physical object. For example, a stored balance card may be implemented as a particular code or password which is associated with an account balance redeemable at a particular merchant. In some embodiments, a stored balance card may be associated with more than one merchant, such as multiple franchises in a particular chain, or multiple stores operated by the same parent company. It should be appreciated that the term “stored balance card” is not intended to refer to credit cards, check cards, or other cards that merely provide access to a user debit or credit account. The term should therefore be understood to exclude accounts that are associated with particular payment processors (e.g., credit card companies) rather than particular merchants.

As used herein, the term “stored balance card information” is used to refer to information related to managing, and accessing a stored balance card. The stored balance card information may include analytic information derived electronic transaction information received regarding the stored balance card, information relating to a consumer associated with the stored balance card, an updated balance of the stored balance card derived from electronic transaction information associated with the stored balance card, promotion information associated with the stored balance card, or the like. The term “stored balance card information” is used in contrast to the term “electronic transaction information”. In the present context, electronic transaction information provides the raw numbers or other information directly related to a transaction performed using the stored balance card, such as the initial balance, information about transactions performed using the stored balance card (e.g., an identifier for the stored balance card, a purchase amount, and/or a list of one or more items purchased in the transaction), information indicating a transaction was approved by a payment processor, or the like. The electronic transaction information may be used to derive the stored balance card information, but the terms are not intended to be used interchangeably.

As used herein, the term “stored balance card balance” is used to refer to the remaining balance, credit, or other redeemable value associated with a stored balance card which may be used at a particular merchant or merchants in exchange for one or more products or services. For example, a given stored balance card may have a balance equal to a certain amount of funds usable to perform transactions with a merchant. Alternatively, a stored balance card balance may be expressed in terms of a particular number of items (e.g., a card good for “6 cups of coffee”) and not tied to a particular fund balance. In this manner, stored balance cards provided based on a stored balance card promotion may be provided using promotions for a certain cash value or a certain number of products.

As used herein, the term “combined stored balance account” is used to refer to a single payment instrument (e.g., a physical card employing magnetic strip or radio frequency identification technology, a virtual code, or the like) that links together a plurality of stored balance cards. This combined stored balance account may provide the consumer with the ability to use the single payment instrument to access multiple different stored balance cards. For example, a consumer may associate a first stored balance card for a coffee shop and a second stored balance card for an electronics store with a single combined stored balance account that is usable at both merchants. If the consumer uses the combined stored balance account to perform a transaction at the coffee shop, the stored balance card associated with the coffee shop will be debited of the value of the transaction, and if the consumer uses the combined stored balance account to perform a transaction at the electronics shop, the stored balance card associated with the electronics shop will be debited of the value of the transaction.

As used herein, the term “wallet account” is used to refer to an account with a balance that is held in escrow or in some other intermediary form until being provided to the merchant as a result of a transaction between a consumer and the merchant. Stored balance cards are generally associated with payment to a particular merchant. Upon the purchase of a stored balance card, the merchant is generally provided with the payment, such that stored balance cards represent a promise to offer goods or services of a particular value in exchange for the currency or funds already received by the merchant. As such, the merchant receives the funds prior to providing any goods or services to the consumer.

In contrast, while a wallet account may be accepted by those same merchants, funds from a wallet account are not transferred to the merchant until the transaction actually occurs. As such, although a wallet account may receive a balance as a result of a transaction with a first merchant (e.g., a promotion and marketing service), funds are not transferred to the merchant who actually provides a good or service until the consumer performs a transaction with that merchant. In this manner, a distinction between wallet accounts and stored balance cards can be drawn in the fact that the wallet account represents funds that are held in escrow or in some other form by an intermediary until the final transaction occurs with the merchant. In some embodiments, a wallet account may be associated with a combined stored balance account such that the wallet account serves as a “backstop” to cover any overages from transactions performed using stored balance cards associated with the stored balance card account. In some embodiments, consumers may add additional stored balance cards to the combined stored balance account to enable the wallet account to be used to cover overages on the added stored balance cards.

### Overview

Merchants sell goods and services (collectively referred to herein as “products”) to consumers. The merchants can often control the form of their product offers, the timing of their product offers, and the price at which the products will be offered. The merchant may sell products at a brick-and-mortar sales location, a virtual online site, or both.

Discounts have been used as part of some retail strategies. Discount techniques include providing coupons and rebates to potential consumers, but these techniques have several disadvantages. In this regard, a number of deficiencies and problems associated with the systems used to, among other things, provide discounts to consumers have been identified.

One form of a promotion is through the use of a stored balance card. Such promotions allow a consumer to purchase a certain value of product with a particular merchant for a reduced price. In this manner, the consumer receives the benefit of a discount while the merchant receives the benefit of the consumer's currency immediately, in exchange for a promise to provide products equivalent to the certain value at a later time. The consumer receives the benefit of a stored balance card equal to the obligation undertaken by the merchant at a reduced price, and the merchant receives a marketing benefit, the benefit of receiving the funds immediately, and the benefit of a reduced obligation to the consumer (e.g., in the case of bankruptcy, such stored balance cards are generally voided). For example, a consumer may purchase a promotion for “$75 of product for $50”, and pay $50 in exchange for a stored balance card with a balance of $75 that is redeemable with a merchant or merchants offering the promotion. In some cases the stored balance card may be physical (e.g., a physical card mailed to the consumer), while in other cases the stored balance card may be virtual or electronic (e.g., a passcode e-mailed or displayed to the consumer). However, consumers may in some cases be reluctant to purchase such promotions due to the additional personal overhead required to manage multiple stored balance cards with different balances.

Some merchants have addressed this problem by offering the ability for consumers to check the status of their stored balance cards through the use of a merchant website. However, this solution requires consumers to maintain multiple logins on multiple websites if they have multiple stored balance cards with available balances. The inventors have identified these and various other problems and difficulties that occur in providing stored balance cards to consumers.

Accordingly, to overcome these problems, example embodiments of the present invention are shown in order to provide improved methods for accessing and managing stored balance card information. Embodiments may provide the ability for consumers and merchants to track and manage stored balance card information such as the balance of stored balance cards associated with particular consumers via a promotion and marketing system. For example, embodiments may provide the ability for consumers to check the current balance of any stored balance card purchased via the promotion and marketing system in a single interface without requiring the consumer to access the particular merchant's website. Embodiments may also provide for aggregation of analytic information derived from the use of stored balance cards in order to provide improved marketing for the merchant. For example, the promotion and marketing service may remind consumers that they have an available balance with a particular merchant, or the promotion and marketing service may notify the merchant of demographic information about consumers with currently outstanding stored balance card balances, information about the consumer's likes, dislikes, interests, location, and the like, or other information derived from the use of stored balance cards. Embodiments may also provide the ability to receive electronic transaction information from the merchant to derive balance, expiration status, and other stored balance information that may then be provided to the merchant or the consumer without requiring the merchant to independently such information.

Embodiments may also provide methods, systems, and apparatuses for facilitating transactions using a combined stored balance account that is also linked to a consumer wallet account. These embodiments may allow consumers to initiate transactions with merchants such that if the transaction exceeds the remaining balance offered on a particular stored balance card, the value of the transaction in excess of the remaining balance is charged to a consumer wallet account also associated with the combined stored balance account.

### System Architecture and Example Apparatus

The method, apparatus, and computer program product of the present invention may be embodied by any of a variety of devices. For example, the method, apparatus, and computer program product of an example embodiment may be embodied by a networked device, such as a server or other network entity, configured to communicate with one or more devices, such as one or more client devices. Additionally or alternatively, the computing device may include fixed computing devices, such as a personal computer or a computer workstation. Still further, an example embodiment may be embodied by any of a variety of mobile terminals, such as a portable digital assistant (PDA), mobile telephone, smartphone, laptop computer, tablet computer, or any combination of the aforementioned devices.

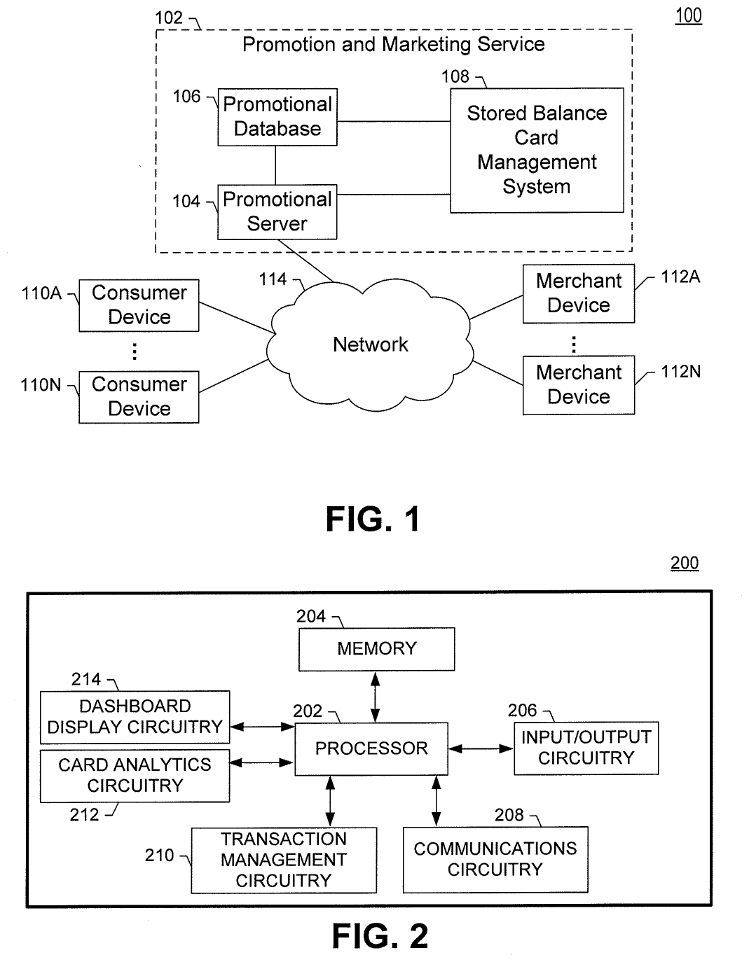

In this regard, FIG. 1 discloses an example computing system within which embodiments of the present invention may operate. Sales representatives and merchants may access a promotion and marketing service 102 via a network 114 (e.g., the Internet, or the like) using computer devices 110A through 110N and 112A through 112N, respectively (e.g., one or more consumer devices 110A-110N or one or more merchant devices 112A-112N). Moreover, the promotion and marketing service 102 may comprise a promotional server 104 in communication with a promotional database 106 and further in communication with a stored balance card management system 108. The promotion and marketing service 102 may be operable to access, manage, derive, and provide stored balance card information to merchants and consumers via the promotion and marketing service 102.

The stored balance card management system 108 may provide the promotion and marketing service 102 with the capability to provide promotions that comprise stored balance cards. These functions may include generating passcodes associated with stored balance cards, authorizing and activating the stored balance cards, and providing the stored balance cards to consumers. As noted above, stored balance cards may be physical, virtual, or both, and the stored balance card management system may facilitate communication or shipping of stored balance cards in accordance with the type of stored balance card offered. The stored balance card management system 108 may further notify merchants of the sale and/or activation of stored balance cards, thus enabling those stored balance cards to be redeemed at the merchant by the consumer.

The stored balance card management system 108 may also communicate with one or more merchant devices 112. The merchant devices 112 may comprise a point-of-sale module that provides electronic transaction information for transactions using a stored balance card. In some embodiments, this electronic transaction information is related to stored balance cards sold by the promotion and marketing service 102, though it should be appreciated that in some embodiments the stored balance card could be sold by the merchant and managed by the promotion and marketing service 102.

In some alternative embodiments, the stored balance card management system 108 may also provide the capability to implement a combined stored balance account including a wallet account in accordance with embodiments of the present invention. It should be readily appreciated that some embodiments may implement such a system as part of a payment processing system, which allows transactions to be performed using a wallet account maintained by the promotion and marketing service 102 as a backstop to transactions performed using a stored balance card. For example, a consumer may initiate a transaction using a stored balance card or combined stored balance account, and, if the value of the transaction exceeds the remaining balance associated with that particular merchant, the stored balance card management system 108 may determine if sufficient funds exist within a wallet account managed or accessed by the promotion and marketing service 102. In such a case, the stored balance card management system 108 may verify that the funds are sufficient and authorize the transaction. It should be appreciated that this function may also be provided by or in concert with various other payment processing tools, services, and the like.

The merchant devices 112 may provide electronic transaction information to the promotion and marketing service 102. The electronic transaction information may include transaction amounts (e.g., a purchase price) and an identifier for the stored value card that was used to complete the purchase. The electronic transaction information may also include information on the particular product purchase, the location at which it was purchased, and various other information associated with the particular transaction. This information may be provided to the stored balance card management system 108 through, for example an application programming interface (API). For example, the merchant may modify their point-of-sale software to send a notification to the stored balance card management system 108 whenever a transaction is completed using a stored balance card. Alternatively, in some embodiments, a point-of-sale system is integrated with both the merchant device and the promotion and marketing service. For example, the merchant device 112A may include a point-of-sale management module (not shown) that enables the merchant to interface with the promotion and marketing service to facilitate the generation of promotions. For example, the promotion and marketing service 102 may be provided with ongoing merchant sale or product inventory information directly through the point-of-sale. The point-of-sale management module may determine which products or services are being sold by the merchant to identify appropriate products and services for newly generated promotions (e.g., suggesting promotions directed to products or services of which the merchant has excess inventory, or suggesting promotions directed to products in which the merchant appears to specialize). In some embodiments, the point-of-sale management module may also interface with a merchant online storefront to perform similar functions. The point-of-sale management module may also be configured to provide transaction data to the promotion and marketing service for determining the type and value of goods sold.

Such a point-of-sale system could also be employed to provide electronic transaction information to the stored balance card management system 108 for the purposes of managing stored balance cards. Example operations of a point-of-sale management module are described further in U.S. patent application Ser. No. 13/839,226, filed Mar. 15, 2013, and U.S. patent application Ser. No. 13/839,414, filed Mar. 15, 2013, which are hereby incorporated by reference in their entirety.

As described above, the merchant device 112 may also be configured to perform transactions using a combined stored balance account or a stored balance card which utilizes a wallet account associated with the promotion and marketing service as a backstop to charge any transaction balances in excess of a remaining balance of a stored balance card. For example, if a transaction initiated by the consumer exceeds the amount remaining on the stored balance card, the merchant device 112 may notify the promotion and marketing service 102 to see if the consumer is associated with a wallet account that contains sufficient funds to cover the remainder of the transaction value. If so, the merchant device 112 may communicate with the promotion and marketing service 102 to authorize the charge of the remainder of the transaction against the consumer's wallet account.

The promotion and marketing service 102 may be embodied by one or more computing systems, such as apparatus 200 shown in FIG. 2. As illustrated in FIG. 2, the apparatus 200 may include a processor 202, a memory 204, an input/output module 206, a communications circuitry 208, a transaction management circuitry 210, a card analytics circuitry 212, and a dashboard display circuitry 214. The apparatus 200 may be configured to execute the operations described below. In some embodiments, the processor 202 (and/or co-processor or any other processing circuitry assisting or otherwise associated with the processor) may be in communication with the memory 204 via a bus for passing information among components of the apparatus. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments of the present invention.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading.

In an example embodiment, the processor 202 may be configured to execute instructions stored in the memory 204 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output circuitry 206 that may, in turn, be in communication with the processor 202 to provide output to the user and, in some embodiments, to receive an indication of a user input. The input/output module includes either hardware or a combination of hardware and software configured to cause presentation of a user interface and may include hardware configured to control a display, a web user interface, a mobile application, a client device, a kiosk, or the like. In some embodiments, the input/output circuitry 206 may also include hardware configured to interface with a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 includes either hardware or a combination of hardware and software that is configured to receive and/or transmit data from/to a network and/or any other device or module in communication with the apparatus 200. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may additionally or alternatively support wired communication. As such, for example, the communication interface may include a communication modem and/or other hardware/software for supporting communication via cable, digital subscriber line (DSL), universal serial bus (USB), or other mechanisms.

The transaction management circuitry 210 includes either hardware or a combination of hardware and software that is configured to receive electronic transaction information for transactions performed using a stored balance card. The electronic transaction information may be provided by a link to a merchant point-of-sale system. For example, a merchant point of sale may send network messages that notify the transaction management circuitry 212 of transactions performed using a stored balance card. These network messages may be received via the communications circuitry 208. In some embodiments, the transaction management circuitry 210 may receive electronic transaction information via an application programming interface (API) offered to facilitate the transfer of electronic transaction information. For example, when a point-of-sale system processes a transaction using a stored balance card, the point-of-sale may detect the use of a stored balance card and call an appropriate API function to notify the transaction management module of the details of the transaction. These details may include the price of the transaction, the items purchased, the location of the transaction, or any other information related to the transaction.

The transaction management circuitry 210 may further facilitate activation and initial registration of stored balance cards with the promotion and marketing service. For example, when a stored balance card promotion is purchased by the consumer, the transaction management circuitry 210 may initialize the stored balance card and associate the stored balance card with a user account of the consumer making the purchase. Similarly, the transaction management circuitry 210 may notify the merchant that a particular stored balance card has been purchased, and that the merchant should enable use of the stored balance card with their point-of-sale system. In some embodiments, the merchant may notify the transaction management circuitry 210 of the activation of a stored balance card. For example, the stored balance card may be sold by the merchant at the merchant's place of business, and the merchant may notify the promotion and marketing service of the sale and the balance of the stored balance card so that the promotion and marketing service can begin monitoring of the stored balance card for that particular consumer. In this manner, some embodiments may facilitate the use of the promotion and marketing service to gather information and provide analytics services even for stored balance cards not purchased via the promotion and marketing service. Some embodiments may support registration of both stored balance cards purchased via a promotion offered by the promotion and marketing service, and stored balance cards purchased directly from the merchant.

The transaction management circuitry 210 may also provide for the matching or a particular transaction to a particular user or users of the promotion and marketing service. For example, the electronic transaction information may include a code or identifier for the particular stored balance card that can be matched to the consumer in a database of sold stored balance cards. Additionally or alternatively the electronic transaction information may include various other identifiers suitable for matching the transaction to a consumer, including a consumer name, address, telephone number, account identifier, e-mail address, or the like.

The card analytics circuitry 212 includes either hardware or a combination of hardware and software that is configured to access, manage, and/or analyze transaction data associated with stored balance cards to derive stored balance card information. The card analytics circuitry 212 may function to derive stored balance card information from transactions performed using a stored balance card. This stored balance card information may include information related to which consumers have a stored balance card with an available balance, demographics of these consumers, which products or services are purchased using stored balance cards, interests of consumers with stored balance cards, or the like. These analytics may be employed to improve marketing efforts to these consumers for both the merchant and the promotion and marketing service. For example, communications may be targeted to consumers with an outstanding balance, encouraging them to apply their balance to particular products or services offered by the associated merchant.

The card analytics circuitry 212 may further monitor incoming transaction data and update balanced information for the stored balance cards monitored by the promotion and marketing service. For example, as transactions are performed using stored balance cards, the card analytics circuitry 212 may reduce balances associated with the cards stored locally within the promotion and marketing service. It should be appreciated that in some embodiments, this process occurs separately from the process of performing and authorizing transactions using the stored balance card. For example, the card analytics module may perform separate calculations to derive stored balance card information that, while they provide some of the same information as that of card issuers or payment processors, occur in parallel to actual management and authorization of transactions. The card analytics circuitry 212 may further provide additional marketing information based on the ability to match a particular consumer to the particular transaction as provided by the transaction management circuitry 210. For example, relevance information or other analytic information associated with the consumer's use of the promotion and marketing service may be correlated with the electronic transaction information to provide additional context and analytic data for both the consumer's interactions with the promotion and marketing service and their interactions with the particular merchant.

The dashboard display circuitry 214 includes either hardware or a combination of hardware and software that is configured to provide stored balance card information to consumers and/or merchants. As noted above, the card analytics circuitry 212 may derive a variety of useful status and marketing information for both consumers and merchants. The dashboard display circuitry 214 includes either hardware or a combination of hardware and software that is configured to make this status and marketing information accessible to consumers (e.g., to display a list of the consumer's active stored balance cards and their current balance) and to merchants (e.g., to notify the merchant of a remaining outstanding balance on stored balance cards purchased by consumers or to notify the merchant of various marketing analytic information derived from monitoring consumer transaction using stored balance cards). Such information may be provided via a web interface, a separate application (e.g., various forms of executable software including but not limited to mobile apps, executable web code, or a client application installed on a user device), or via any other format.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by the example displays discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Electronic Marketing Information Service Data Flow

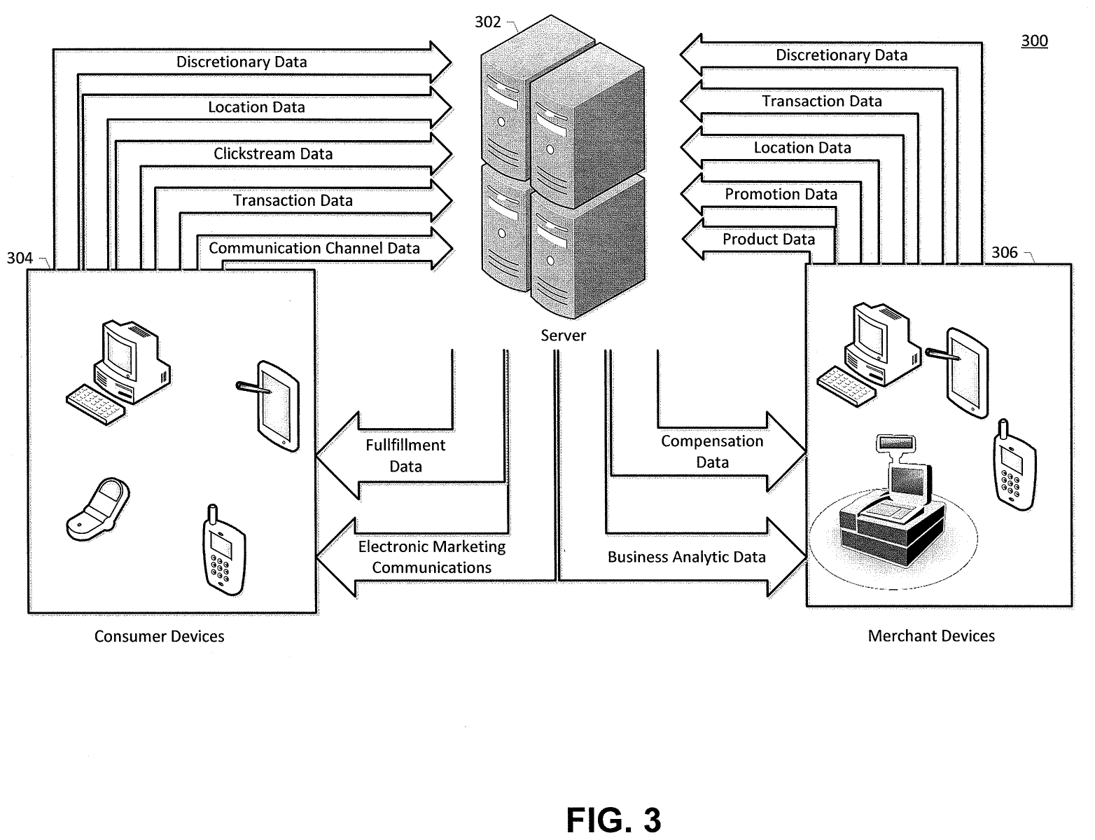

FIG. 3 depicts an example data flow 300 illustrating interactions between a server 302, one or more consumer devices 304, and one or more merchant devices 306. The server 302 may be implemented in the same or a similar fashion as the server 104 as described above with respect to FIG. 1 and/or the apparatus 200 described above with respect to FIG. 2, the one or more consumer devices 304 may be implemented in the same or a similar fashion as the consumer devices 110A-110N as described above with respect to FIG. 1, and the one or more merchant devices 306 may be implemented in the same or a similar fashion as the merchant devices 112A-112N as described above with respect to FIG. 1.

The data flow 300 illustrates how electronic information may be passed among various systems when employing a server 302 in accordance with embodiments of the present invention. The one or more consumer devices 304 and/or one or more merchant devices 306 may provide a variety of electronic marketing information to the server 302 for use in providing promotion and marketing services to the consumer. This electronic marketing information may include, but is not limited to, location data, clickstream data, transaction data, communication channel data, and/or discretionary data.

As a result of transactions performed between the one or more consumer devices 304 and the server 302, the server 302 may provide fulfillment data to the consumer devices. The fulfillment data may include information indicating whether the transaction was successful, the location and time the product will be provided to the consumer, instruments for redeeming promotions purchased by the consumer, or the like.

In addition to the e-commerce interactions with the one or more consumer devices 304 offered by the server 302, the server 302 may leverage information provided by the consumer devices to improve the relevancy of electronic marketing communications to individual consumers or groups of consumers. In this manner, the server 302 may determine promotions, goods, and services that are more likely to be of interest to a particular consumer or group of consumers based on clickstream data, location data, and other information provided by and/or relating to particular consumers. For example, the server 302 may detect the location of a consumer based on location data provided by the consumer device, and offer promotions based on the proximity of the consumer to the merchant associated with those promotions.

Alternatively, the server 302 may note that the consumer has an interest in a particular hobby (e.g., skiing) based on electronic marketing information associated with the consumer (e.g., a browser cookie that indicates they frequently visit websites that provide snowfall forecasts for particular ski resorts), and offer promotions associated with that hobby (e.g., a promotion offering discounted ski equipment rentals or lift tickets). It should be appreciated that a variety of different types of electronic marketing information could be provided to the server 302 for the purpose of improving the relevancy of marketing communications. It should also be appreciated that this electronic marketing information may be received from a variety of electronic sources, including various consumer devices, merchant devices, and other sources both internal and external to a promotion and marketing service. For example, other data sources may include imported contact databases maintained by merchants, electronic survey questions answered by consumers, and/or various other forms of electronic data.

It should also be appreciated that the server 302 may also control other factors of the electronic marketing communications sent to the consumer other than the particular promotions included in the electronic marketing communication. For example, the server 302 may determine the form, structure, frequency, and type of the electronic marketing communication. As with the content of the electronic marketing communication, these factors may be programmatically determined according to various methods, factors, and processes based on electronic data received by the server 302 for the purpose of maximize the likelihood that the communication will be relevant to the recipient consumer.

The server 302 interactions with the one or more merchant devices 306 may be related to enabling the merchant to market their products using a promotion and marketing service. For example, the one or more merchant devices 306 may provide promotion data defining one or more promotions to be offered by the promotion and marketing service on behalf of the merchant. The server 302 may receive this information and generate information for providing such promotions via an e-commerce interface, making the promotions available for purchase by consumers. The server 302 may also receive information about products from the one or more merchant devices 306. For example, a merchant may provide electronic marketing information indicating particular products, product prices, inventory levels, and the like to be marketed via a promotion and marketing service. In some embodiments, one or more of the merchant devices may be a payment processing system configured to process payments for a merchant. The server 302 may receive this information and generate listing information to offer the indicating products to consumers via a promotion and marketing service.

The one or more merchant devices 306 may also receive information from the server 302. For example, in some embodiments a merchant may obtain access to certain business analytic data aggregated, generated, or maintained by the server 302. As a particular example, a merchant might offer to pay for consumer demographic data related to products or services offered by the merchant. It should be appreciated however, that a merchant may not need to list any products or services via the promotion and marketing service in order to obtain such data. For example, the promotion and marketing service may enable merchants to access electronic marketing data offered via the promotion and marketing service based on a subscription model.

The one or more merchant devices 306 may also receive electronic compensation data from the server 302. For example, when a promotion or product is sold by the promotion and marketing service on behalf of the merchant, a portion of the received funds may be transmitted to the merchant. The compensation data may include information sufficient to notify the merchant that such funds are being or have been transmitted. In some embodiments, the compensation data may take the form of an electronic wire transfer directly to a merchant account. In some other embodiments, the compensation data may indicate that a promotion or product has been purchased, but the actual transfer of funds may occur at a later time. For example, in some embodiments, compensation data indicating the sale of a promotion may be provided immediately, but funds may not be transferred to the merchant until the promotion is redeemed by the consumer. The electronic compensation data may include electronic transaction data as described above and herein, such that the merchant devices 306 transmit electronic data to the server 302 indicating that transactions have been performed using a stored balance card as payment.

Embodiments advantageously provide for improvements to the server 302 by improving the quality of electronic marketing communications transmitted from the server 302 to the consumer devices 304 by identifying trending promotions for inclusion in said electronic marketing communications. In this manner, embodiments offer improvements to the methods by which particular promotions are selected for as trending and improvements to the methods for which velocity metrics are calculated to select those trending promotions. In particular, embodiments provide improved techniques for evaluating transaction data over a plurality of time periods to identify the velocity metrics, along with sophisticated evaluation and filtering techniques to ensure that promotions identified as trending are available, valid, useful, and/or of interest to consumers. These improvements serve to reduce the number of electronic marketing communications that must be sent by the server 302 in order to produce sales, conserving system resources. Furthermore, by providing more accurate identification of trending promotions, the consumer may gain the same benefit with less system interaction, thus conserving system resources and improving the technical functionality of both the consumer devices 304 and the server 302.

### Example Dataflow

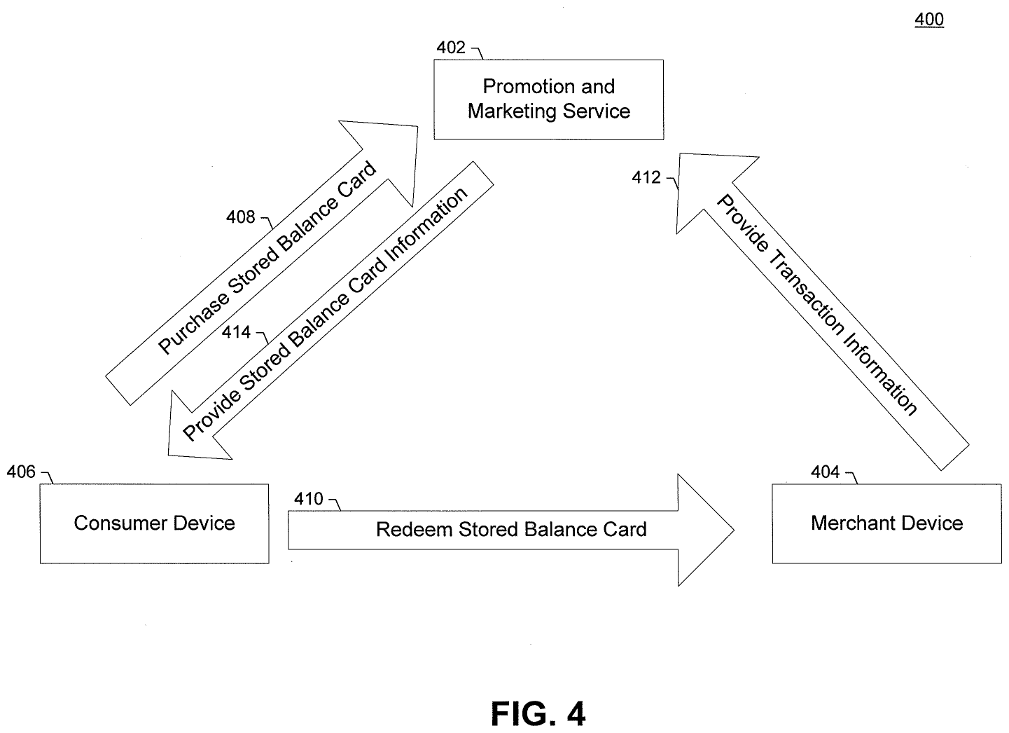

FIG. 4 depicts an example dataflow 400 illustrating a process for providing stored balance card information in accordance with some embodiments of the present invention. The dataflow 400 may, for example, be implemented by an apparatus, such as described above with respect to the apparatus 200, or as part of a promotion and marketing service 102 and/or by a promotional server 104 as described above with respect to FIG. 1. The dataflow 400 illustrates how a stored balance card may be obtained via a promotion and marketing service 402, electronic transaction information may be provided by a merchant 404 to the promotion and marketing service, and the promotion and marketing service 402 may provide stored balance card information to a consumer 406.

At action 408 of the dataflow, a consumer uses a consumer device 406 to purchase a stored balance card from the promotion and marketing service 402. For example, the consumer may purchase a promotion that provides the consumer with a certain amount of credit usable at the merchant as a stored balance card. This stored balance card may take the form of a special code that the consumer may enter at the merchant website or point-of-sale which will debit the consumer's stored balance card as the consumer makes purchases. This act of purchasing the stored balance card may further include validating and activating the stored balance card with the merchant device, via a step not pictured. In other embodiments, the stored balance card may be pre-validated by the merchant before it is sold to the consumer. For example, the merchant may generate a set number of stored balance card codes which are provided to the promotion and marketing service and redeemable upon receipt by the promotion and marketing services, thus eliminating the need for a separate activation process after the stored balance card code is sold.

At action 410, the consumer performs a transaction with a merchant device (e.g., a merchant e-commerce website or point-of-sale system). During this transaction, the stored balance card is verified and debited as known in the art. Although the promotion and marketing service 402 may perform these functions in some embodiments, it should be appreciated that in various embodiments the promotion and marketing service 402 does not function to verify, authorize, or authenticate the transaction, with these functions instead provided by another third party payment processor (e.g., a bank or credit card company).

The promotion and marketing service 402 is provided with electronic transaction information at action 412 for the transaction performed between the consumer and merchant at action 410. As described above, this electronic transaction information may be provided using a transaction API built into the merchant point-of-sale and configured to notify the promotion and marketing service of electronic transaction information. The promotion and marketing service 402 may use this electronic transaction information to derive various stored balance card information, such as the status of the card, the remaining balance or the expiration date, analytic information, such as consumer demographics, consumer interests, consumer impression counts, or other marketing information, or the like. It should be appreciated that the electronic transaction information is understood to be distinct from the stored balance card information, in that the stored balance card information is derived from the raw transaction data. Some embodiments may provide access to the transaction data in addition to the stored balance card information.

At action 414, the stored balance card information is provided to the consumer. It should be appreciated that although the instant illustration depicts the stored balance card information being provided to the consumer, such information could also or alternatively be provided to the merchant. For example, the consumer may be provided with up to date balance and expiration date information for the stored balance card, and the merchant may be provided with consumer demographic and other marketing information for consumers associated with stored balance cards offered by the merchant through the promotion and marketing service.

### Example Communications Among a Consumer Device, a Merchant Device, and the Promotion and Marketing Service

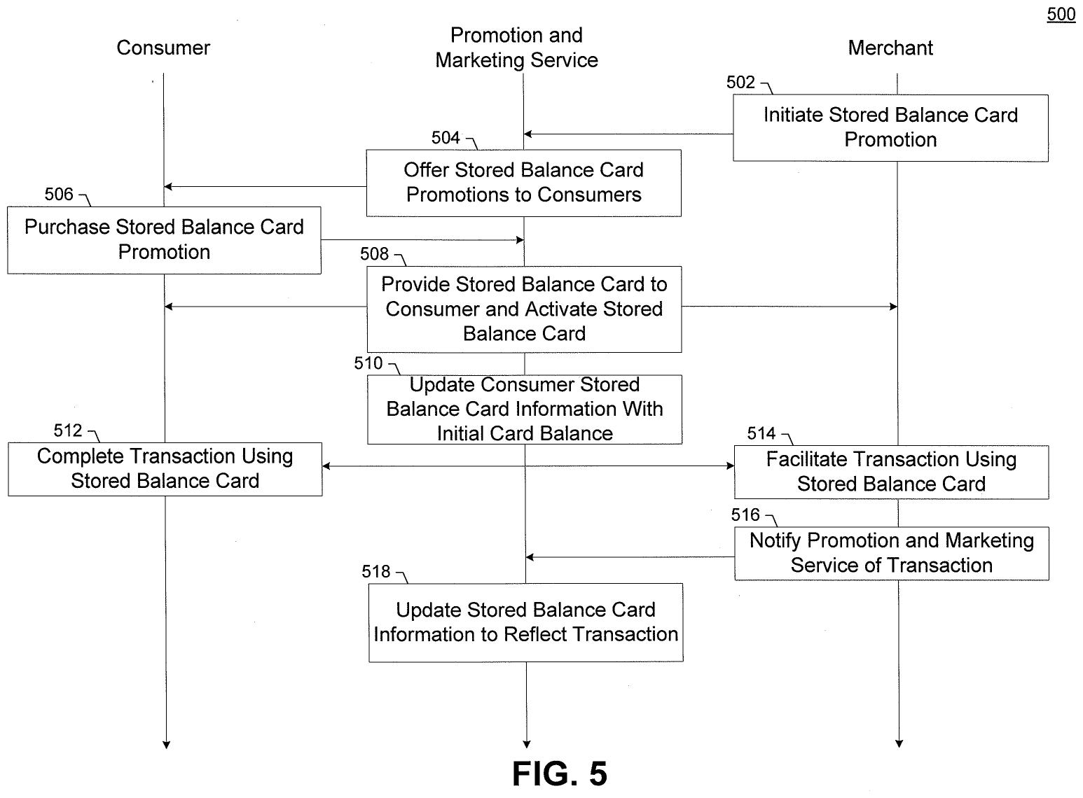

FIG. 5 is a signaling diagram illustrating an example communication 500 among a consumer device, a merchant device, and a promotion and marketing service. As described above, these actors may communicate among one another to facilitate the generation and provision of stored balance card information. The promotion and marketing service may provide a promotion incorporating the use or sale of one or more stored balance cards offered by a merchant, and receive electronic transaction information from the merchant from the use of those stored balance cards. The consumer and merchant may be provided with stored balance information derived from that electronic transaction information to assist consumers with monitoring of their stored balance cards and merchants with improved analytics and marketing opportunities. The methods and processes described with respect to FIG. 5 may be performed by one or more apparatuses, such as the apparatus 200 described with respect to FIG. 2, or by elements of a promotional and marketing service as described with respect to FIG. 1.

At action 502, a stored balance card promotion is initiated. For example, a merchant may notify the promotion and marketing service they wish to offer a certain number of stored balance cards at a certain price. The merchant and promotion and marketing service may negotiate to determine a commission or price obtained by the promotion and marketing service for the sale of each stored balance card. Once the terms of the promotion are agreed upon by the merchant and the promotion and marketing service, the promotion and marketing service may offer the stored balance card promotions to consumers at action 504. It should be appreciated that while the instant example is provided with respect to a system whereby the stored balance cards are purchased through the promotion and marketing service, other embodiments are also envisioned where the stored balance cards are obtained through alternative means, such as by obtaining directly from the merchant, by another third party, or the like.

At action 506, the consumer purchases one of the stored balance card promotions. At action 508, the promotion and marketing service provides the stored balance card to the consumer, associates the consumer with the particular stored balance card, and notifies the merchant of the sale of the stored balance card to activate the card. As noted above with respect to FIG. 4, the stored balance card may already be activated at the time of the sale, such that activation is not necessary by the promotion and marketing service. As yet another alternative, the merchant may take the additional step of activating the stored balance card with a card issuer or payment processor (step not pictured).

At action 510, the promotion and marketing service updates the consumer's stored balance card information with the initial balance of the stored balance card. This stored balance card information may be provided to the consumer through the use of a stored balance card dashboard hosted by the promotion and marketing service. At action 512, the consumer completes a transaction with the merchant using the stored balance card, and at action 514, the merchant facilitates this transaction. For example, the consumer may enter a code corresponding to the stored balance card on a merchant website, and the merchant may authenticate the stored balance card with a payment processor and debit the stored balance of the stored balance card by the amount of the transaction. Alternatively, in some embodiments the consumer may be provided with a physical token for the stored balance card (e.g., a physical card with a magnetic strip, an NFC chip, or an RFID token), which may be swiped, scanned, or the like at a merchant point-of-sale to perform the transaction.

At action 516, the merchant notifies the promotion and marketing service of the transaction. This notification may occur via a variety of methods. For example, the merchant may manually notify the promotion and marketing service, such as with an e-mail or fillable web form. Alternatively, the merchant point-of-sale system may automatically generate electronic transaction information to be sent to the promotion and marketing service, such as via an API. As yet another alternative, a report may be sent to the promotion and marketing service at particular intervals (e.g., daily) to notify the promotion and marketing service of transactions performed using a stored balance card. As yet another alternative, in some embodiments the promotion and marketing service may function as a payment processor, authorizing the transaction performed using the stored balance card, and the promotion and marketing service may gather transaction data during the authorization process.

It should be readily appreciated that the stored balance card information may include information for a variety of stored balance cards and/or merchants. For example, the consumer may be able to view information associated with cards from a plurality of merchants, with a different balance for each, via a single interface provided by the promotion and marketing service. In some embodiments, the stored balance card information available to the merchant is limited to stored balance card information associated with transactions performed using stored balance cards associated with the merchant, or with such information plus general information maintained by the promotion and marketing service. In other embodiments, the stored balance card information provided to the merchant may include information derived from all stored balance card transactions performed by the consumer or a group of consumers. For example, merchants may be allowed to “opt in” to data gathering operations such that stored balance card information representing market analytics across all merchants is only provided to merchants that allow their electronic transaction information to be provided to other merchants. In this manner, merchants may be rewarded with additional marketing information if they make their marketing information available to others.

At action 518, the stored balance card information is updated to reflect the new electronic transaction information. For example, the user's balance as monitored by the promotion and marketing service may be reduced by the amount of the transaction, or new analytic data associated with the transaction may be added to a marketing database accessible to the promotion and marketing service and/or the merchant.

### Example Processing Operations Performed by Configured Apparatuses

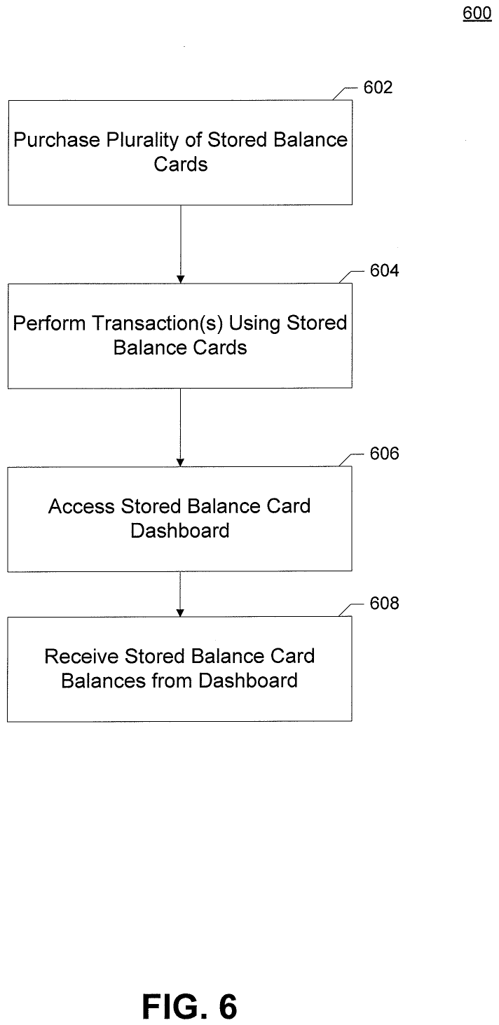

FIGS. 6-8 show example methods, namely processes 600, 700, and 800 that may be executed by one or more machines (some examples of which are discussed in connection with FIGS. 1 and 2), in accordance with some embodiments discussed herein. These processes may be performed by computing devices as known in the art and described above with respect to FIGS. 1 and 2.

FIG. 6 depicts an example process 600 for receiving stored balance card information from the perspective of the consumer. In this manner, consumers may purchase a plurality of stored balance cards from a plurality of merchants, and have easy access to stored balance card information such as card status information in a single location. The process 600 describes one exemplary method by which a consumer device may receive this stored balance card information. The process 600 may be performed by an apparatus, such as the apparatus 200 described with respect to FIG. 2, or one of the consumer devices 110 described with respect to FIG. 1.

At action 602, a plurality of stored balance cards are purchased. These stored balance cards may be purchased from multiple merchants. In some embodiments, the stored balance cards are purchased via the promotion and marketing service. When stored balance cards are purchased in this manner, they may be registered with a particular consumer account of the promotion and marketing service.

At action 604, the stored balance cards are used to perform a transaction or transactions with a merchant or merchants. As these transactions are performed, the balance of the stored balance cards is updated to reflect the transactions. At action 606, the consumer device may access a stored balance card dashboard, such as a website associated with the consumer, hosted by the promotion and marketing service. At action 608, this stored balance card dashboard may provide the consumer with stored balance card information, such as the current balance of the stored balance cards, any expiration date of the stored balance, cards, or the like. It should be appreciated that the consumer device may also receive additional forms of stored balance card information or information derived therefrom. For example, in some embodiments the consumer device may receive e-mail or other communications from the promotion and marketing service based on the stored balance card information. As a specific example, the promotion and marketing service may generate an e-mail to remind the consumer that the consumer has a remaining balance available on a particular stored balance card.

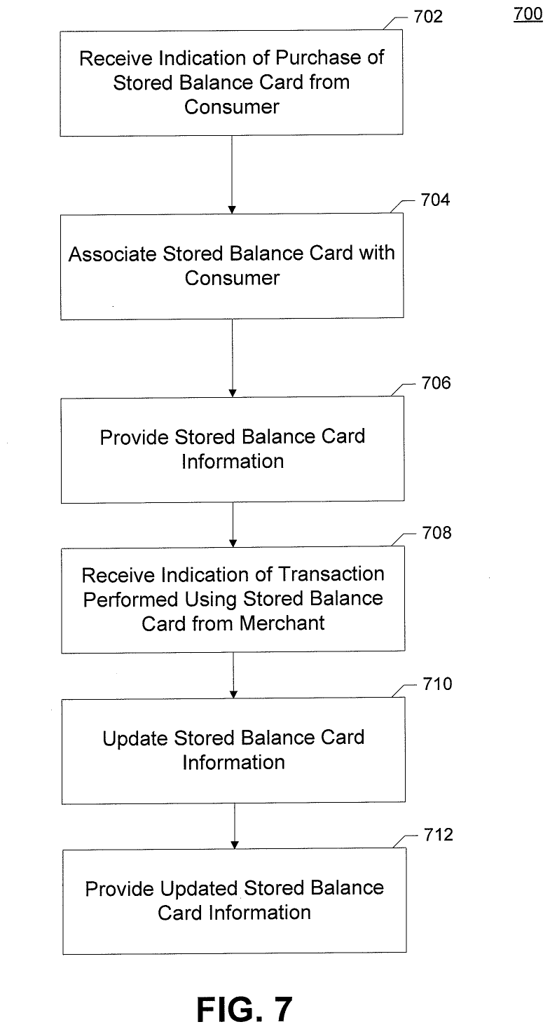

FIG. 7 depicts an example process 700 for determining and providing stored balance card information in accordance with embodiments of the present invention. As described above, the promotion and marketing service may facilitate the sale and marketing of stored balance cards to consumers. After those stored balance cards are purchased, the promotion and marketing service may derive stored balance card information from the consumer's interaction with those stored balance cards. Such information may include electronic transaction information provided by a merchant for transactions using the stored balance cards. Other such information may include the lack of a purchase using a particular card (e.g., an awareness of “stale” stored balance cards that have not been used in a threshold amount of time), other purchases made by the consumer that purchased the stored balance card, or the like. The process 600 illustrates one example of how such stored balance card information may be derived and provided to consumers and/or merchants. The process 700 may be performed by an apparatus, such as the apparatus 200 described with respect to FIG. 2, or the promotion and marketing service 102 described with respect to FIG. 1.

At action 702, an indication of the purchase of a stored balance card is received. For example, this indication of a purchase may include a purchase made by the consumer using the promotion and marketing service, the indication of purchase may be received from the merchant (e.g., the user purchases the stored balance card at the merchant's website, brick and mortar store, or the like), or the stored balance card may be issued in response to a return made by the consumer (e.g., as store credit offered for the return of an item instead of a cash refund).

At action 704, the stored balance card is associated with a consumer. As noted above with respect to FIG. 2, the stored balance card may be associated with a particular user account of the promotion and marketing service via a variety of methods, such as by noting the user account used to purchase the stored balance card, noting a user account indicated as a gift recipient of the stored balance card, matching an e-mail address to a user account, or the like. In some embodiments, the stored balance card may be associated with a newly generated user account or identifier, such as in the case where the stored balance card cannot be matched to a particular user. In some embodiments, the user may be able to provide an identifier for the stored balance card to access this newly generated account, which may then be registered as a new user account that may later be used by the consumer to purchase other promotions.

At action 706, the stored balance card information is provided. For example, the consumer may log in to their user account and be presented with a dashboard that indicates the remaining balances and expiration dates of all stored balance cards associated with the account. As another example, the merchant may be provided with analytic information for stored balance cards sold for the merchant account.

At action 708, an indication of a transaction using the stored balance card is received. This transaction may be provided upon the merchant finalizing a transaction with the consumer, such as sale or lease of a product or service. The merchant may provide information such as the amount of the transaction, an identifier for the consumer performing the transaction, the date of the transaction, the products or services involved in the transaction, the location of the transaction, or the like.

At action 710, the stored balance card information is updated based on the transaction. For example, stored balance card analytics may be updated to reflect the new electronic transaction information and the remaining balance on the stored balance card as monitored by the promotion and marketing service may be updated. At action 712, the updated stored balance card information is provided to the consumer and/or merchant.

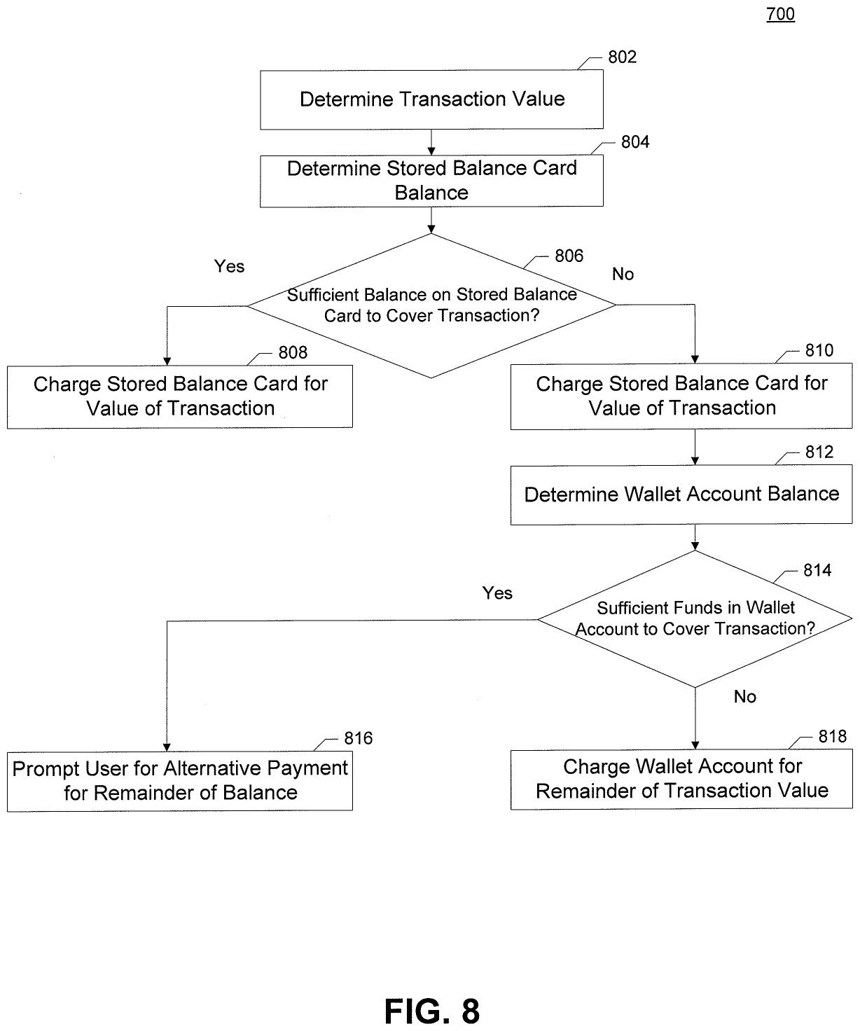

FIG. 8 depicts an example of a process 800 for facilitating transactions using a stored balance card in conjunction with a wallet account in accordance with embodiments of the present invention. As described above, embodiments may provide the ability to associate multiple stored balance cards with a single instrument, such as a combined stored balance account. The process 800 describes how stored balance cards and/or a combined stored balance account may be further linked with a wallet account to facilitate the use of the wallet account in situations where an amount of a particular transaction exceeds the remaining balance of a stored balance card. In this manner, the wallet account may be used to increase the flexibility of a stored balance card or a combined stored balance account by allowing a consumer to use a single payment method for a transaction even when the amount of the transaction exceeds the balance of a stored balance card. The process 800 may be performed by an apparatus, such as the apparatus 200 described with respect to FIG. 2, one of the merchant devices 112, or the promotion and marketing service 102 described with respect to FIG. 1.

At action 802, a value of a particular transaction is determined. The transaction may be for a purchase of goods and services from a merchant by a consumer. For example, a point-of-sale or e-commerce system may determine the price of goods or services associated with the transaction at the time the consumer wishes to complete the transaction. This information may be provided to a promotion and marketing system from a merchant, or determined as a result of a consumer interaction with the promotion and marketing service.

At action 804, a balance is determined for a stored balance card. During the transaction, the consumer may provide a stored balance card or combined stored balance account containing a stored balance card associated with the merchant that is involved with the transaction. To provide the stored balance card, the consumer may provide a special code associated with the stored balance card account, swipe a physical card on a magnetic card reader, scan a radio frequency identifier chip embedded in a physical token, scan a quick response code to a merchant's point-of-sale, or the like. As noted above, in some embodiments providing the stored balance card may include scanning or swiping a card associated with a combined stored balance account. Upon accessing the combined stored balance account, a stored balance card associated with the particular merchant may be accessed to ascertain the balance available for use with the particular merchant. For example, a merchant point-of-sale may scan a combined stored balance account and communicate with a third party payment processing system to determine the balance of a stored balance card available to the particular merchant.

At action 806, a determination is made as to whether the stored balance card has a sufficient balance to cover the transaction. If so, the process 800 proceeds to action 808 and the transaction is completed by charging the stored balance card for the value of the transaction. Otherwise, the process proceeds to action 810.

At action 810, the stored balance card is charged in the amount of the transaction, resulting in a zero balance on the stored balance card, since the balance was determined not to be sufficient to cover the transaction at action 806. The process 800 then proceeds to action 812, where a wallet account balance associated with the stored balance card is determined. This wallet account may be associated with the stored balance card in a variety of ways. For example, at the time the consumer purchases the stored balance card, the consumer may indicate a particular wallet account to be used in conjunction with the stored balance card.

Alternatively, the consumer may possess a combined stored balance account associated with the wallet account, and individual stored balance cards may be associated with the combined stored balance account at the consumer's request. For example, the consumer may maintain a wallet account associated with the promotion and marketing service. This wallet account may be used to perform transactions with the promotion and marketing service along with any merchants designated by the promotion and marketing service. The consumer may be provided with a particular payment instrument (e.g., a unique identifier or code, or a physical card with a magnetic strip) associated with the wallet account. The promotion and marketing service may further allow the consumer to associate stored balance cards with the combined stored balance account already associated with the consumer's wallet account maintained by the promotion and marketing service. When the consumer makes a transaction using the combined stored balance account, the wallet account offered by the promotion and marketing service may be used to cover any deficiency in the stored balance card associated with the combined stored balance account.

At action 814, a determination is made as to whether sufficient funds exist in the wallet account to cover the remainder of the transaction. If sufficient funds do not exist, the consumer may be prompted at action 816 to provide an alternate form of payment to cover any deficiency. If sufficient funds exist, the wallet account may be charged for the remainder of the transaction value at action 818. When the wallet account is charged, this may cause funds to be provided from a maintainer of the wallet account (e.g., the promotion and marketing service) to the merchant to cover the remainder of the transaction. In this manner, embodiments may advantageously allow for the use of both a stored balance card and a wallet account in a single transaction, without requiring the consumer to independently specify each payment method. Furthermore, a single combined balance card may be associated with a wallet account which is used to “backstop” multiple stored balance cards associated with the combined stored balance account. In this manner, transactions may be performed more efficiently because users do not have to enter multiple payment methods at the time of purchase if their stored balance card has an insufficient balance.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus, such as the processor 202, as discussed above with reference to FIG. 2, to produce a machine, such that the computer program product includes the instructions which execute on the computer or other programmable data processing apparatus create a means for implementing the functions specified in the flowchart block or blocks.

These computer program instructions may also be stored in a computer-readable storage device (e.g., the memory 204) that can direct a computer or other programmable data processing apparatus to function in a particular manner, such that the instructions stored in the computer-readable storage device produce an article of manufacture including computer-readable instructions for implementing the functions discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-48. (canceled)

49. An apparatus comprising a promotion and marketing service, a promotional server of the promotion and marketing service, and a promotional database of the promotion and marketing service, the apparatus for performing a transaction using a stored balance card account, the apparatus further comprising at least one processor coupled to a memory, the memory storing computer executable instructions that, when executed by the at least one processor, configure the apparatus to:
provide, by the promotion and marketing service, the promotional database configured to store data combined stored balance account associated with a user account, the combined stored balance account comprising a wallet account maintained by the promotion and marketing service;
associate, by the promotion and marketing service via the promotional database, stored balance card information comprising a plurality of stored balance card accounts maintained by the promotion and marketing service with the combined stored balance account to link the stored balance card information to the combined stored balance account, the plurality of stored balance card accounts associated with the user account, wherein the stored balance card information comprises a stored balance card account identifier associated with each stored balance card account representing at least one of the plurality of stored balance card accounts maintained by the promotion and marketing service, and
receive, from a merchant device associated with a merchant and by transaction management circuitry of the promotional server, transaction data and the stored balance card account identifier; and
execute, without communicating with any external payment processor, a transaction via the combined stored balance account using the transaction data and the stored balance card account identifier, wherein to perform the transaction, the apparatus is caused to:
retrieve, from the promotional database via the combined stored balance account, the stored balance card information including stored balance card balance data associated with stored balance card accounts of the plurality of stored balance card accounts that are redeemable at the merchant corresponding to the stored balance card account identifier;
automatically retrieve, in response to determining that the stored balance card balance data is insufficient to fully execute the transaction, wallet account balance data associated with the wallet account; and
automatically modifying the wallet account balance data to complete execution of the transaction.

50. The apparatus of claim 49, wherein the computer executable instructions are configured, when executed by the at least one processor, to cause the apparatus to:
identify a promotion based on electronic marketing information associated with at least the user account, wherein the promotion is associated with the at least one of the plurality of stored balance card accounts;
provide the promotion to the user account; and
associate the at least one of the plurality of stored balance card accounts with the user account in response to receiving an indication the user account purchased the promotion.

51. The apparatus of claim 49, wherein the computer executable instructions are configured, when executed by the at least one processor, to cause the apparatus to:
derive remaining stored balance card information based at least on the transaction; and
provide at least one electronic communication to a consumer device based at least on the derived remaining stored balance card information.

52. The apparatus of claim 49, wherein the computer executable instructions are configured, when executed by the at least one processor, to cause the apparatus to:
modify the stored balance card account based on the transaction and further based on the modification to the wallet account balance data.

53. The apparatus of claim 49, wherein the computer executable instructions are configured, when executed by the at least one processor, to cause the apparatus to:
receive contextual data regarding the user account, wherein the contextual data comprises a first portion received in response to first user interaction with a server external to the promotion and marketing service via the at least one consumer device associated with the user account, and wherein the contextual data comprises a second portion received in response to second user interaction with the promotion and marketing service via at least one consumer device associated with the user account;
determine, by the promotion and marketing service, a plurality of relevant promotions associated with the user account of the promotion and marketing service from an available promotion set; and
provide, by the promotion and marketing service, the plurality of relevant promotions to the at least one consumer device associated with the user account, wherein the plurality of stored balance card accounts are generated in response to user interaction with each relevant promotion of the plurality of relevant promotions provided to the at least one consumer device associated with the user account.

54. The apparatus of claim 53, wherein the computer executable instructions are configured, when executed by the at least one processor, to cause the apparatus to:
associate, by the promotional server, at least one promotion of the plurality of relevant promotions with the user account, the at least one promotion associated with a first stored balance card account of the plurality of stored balance card accounts; and
generate, by the promotional server, transfer of a value associated with the first stored balance card account to one or more merchant devices corresponding to the merchant associated with the at least one promotion,
wherein the transfer of the value occurs before execution of the transaction.

55. The apparatus of claim 54, wherein the computer executable instructions are configured, when executed by the at least one processor, to cause the apparatus to:
receive, by the promotional server, a purchase request associated with the at least one promotion; and
processing, by the promotional server, the purchase request associated with the at least one promotion, wherein at least one promotion is associated with the at least one promotion is associated with the user account in response to processing the purchase request.

56. A method involving a promotion and marketing service, a promotional server of the promotion and marketing service, and a promotional database of the promotion and marketing service, the method comprising:
providing, by the promotion and marketing service, the promotional database configured to store data combined stored balance account associated with a user account, the combined stored balance account comprising a wallet account maintained by the promotion and marketing service;
associating, by the promotion and marketing service via the promotional database, stored balance card information comprising a plurality of stored balance card accounts maintained by the promotion and marketing service with the combined stored balance account to link the stored balance card information to the combined stored balance account, the plurality of stored balance card accounts associated with the user account, wherein the stored balance card information comprises a stored balance card account identifier associated with each stored balance card account representing at least one of the plurality of stored balance card accounts maintained by the promotion and marketing service, and
receiving, from a merchant device associated with a merchant and by transaction management circuitry of the promotional server, transaction data and the stored balance card account identifier; and
executing, without communicating with any external payment processor, a transaction via the combined stored balance account using the transaction data and the stored balance card account identifier, wherein executing the transaction comprises:
retrieving, from the promotional database via the combined stored balance account, the stored balance card information including stored balance card balance data associated with stored balance card accounts of the plurality of stored balance card accounts that are redeemable at the merchant corresponding to the stored balance card account identifier;
automatically retrieving, in response to determining that the stored balance card balance data is insufficient to fully execute the transaction, wallet account balance data associated with the wallet account; and
automatically modifying the wallet account balance data to complete execution of the transaction.

57. The method of claim 56 further comprising:
identifying a promotion based on electronic marketing information associated with at least the user account, wherein the promotion is associated with the at least one of the plurality of stored balance card accounts;
providing the promotion to the user account; and
associating the at least one of the plurality of stored balance card accounts with the user account in response to receiving an indication the user account purchased the promotion.

58. The method of claim 56 further comprising:
deriving remaining stored balance card information based at least on the transaction; and
providing at least one electronic communication to a consumer device based at least on the derived remaining stored balance card information.

59. The method of claim 56 further comprising:
modifying the stored balance card account based on the transaction and further based on the modification to the wallet account balance data.

60. The method of claim 56 further comprising:
receiving contextual data regarding the user account, wherein the contextual data comprises a first portion received in response to first user interaction with a server external to the promotion and marketing service via the at least one consumer device associated with the user account, and wherein the contextual data comprises a second portion received in response to second user interaction with the promotion and marketing service via at least one consumer device associated with the user account;
determine, by the promotion and marketing service, a plurality of relevant promotions associated with the user account of the promotion and marketing service from an available promotion set; and
provide, by the promotion and marketing service, the plurality of relevant promotions to the at least one consumer device associated with the user account, wherein the plurality of stored balance card accounts are generated in response to user interaction with each relevant promotion of the plurality of relevant promotions provided to the at least one consumer device associated with the user account.

61. The method of claim 60 further comprising:
associating, by the promotional server, at least one promotion of the plurality of relevant promotions with the user account, the at least one promotion associated with a first stored balance card account of the plurality of stored balance card accounts; and
generating, by the promotional server, transfer of a value associated with the first stored balance card account to one or more merchant devices corresponding to the merchant associated with the at least one promotion,
wherein the transfer of the value occurs before execution of the transaction.

62. The method of claim 60 further comprising:
receiving, by the promotional server, a purchase request associated with the at least one promotion; and
processing, by the promotional server, the purchase request associated with the at least one promotion, wherein at least one promotion is associated with the at least one promotion is associated with the user account in response to processing the purchase request.
